(19) United States
(12) Patent Application Publication
(10) Pub. No.: US 2020/0372462 A1
(43) Pub. Date: Nov. 26, 2020

(54) ORDER DISPLAY METHOD AND APPARATUS

(71) Applicants: Beijing Jingdong Shangke Information Technology Co., Ltd., Beijing (CN); Beijing Jingdong Century Trading Co., Ltd., Beijing (CN)

(72) Inventors: Yingying QI, Beijing (CN); Yanchao MIAO, Beijing (CN)

(21) Appl. No.: 16/603,231

(22) PCT Filed: Mar. 23, 2018
(86) PCT No.: PCT/CN2018/080266

§ 371 Date: Oct. 6, 2019

(30) Foreign Application Priority Data
May 19, 2017 (CN) 201710358302.X

(51) Int. Cl. G06Q 10/08; G06Q 30/06; G06K 9/62

(52) U.S. Cl. CPC G06Q 10/08355; G06K 9/6218; G06Q 30/0635

(57) ABSTRACT

The present application discloses an order display method and apparatus. A specific embodiment of the method comprises: acquiring a first preset number of pieces of order data, the order data comprising a delivery address; separately converting the acquired delivery address of each piece of order data into three-dimensional coordinates corresponding to the acquired delivery address of each piece of order data; clustering the three-dimensional coordinates corresponding to the acquired delivery address of each piece of order data so as to generate a second preset number of order sets; selecting at least one order set from each generated order set; and displaying each piece of order data comprised in the selected order set. The embodiment implements clustering of a large amount of order data into a plurality of order sets, and allows target delivery personnel to sequentially distribute orders corresponding to respective order sets, facilitating improvement of order delivery efficiency.

### CROSS-REFERENCE TO RELATED APPLICATIONS

This application claims the priority to Chinese Patent Application No. “201710358302.X” filed on May 19, 2017, the disclosure of which is hereby incorporated by reference in its entirety.

### TECHNICAL FIELD

The present disclosure relates to the field of computer technology, specifically to the field of Internet technology, and more specifically to a method and apparatus for displaying an order.

### BACKGROUND

With the popularity of the Internet, the advantages of online shopping have become more prominent. The number of users shopping on the Internet is continuously growing, and thus the number of online orders is also growing rapidly.

Generally, in the existing order delivery approaches, a delivery personnel downloads a large amount of order data from a backend server using a terminal device, loads items corresponding to the downloaded large amount of order data into a truck; and then arranges a delivery route based on his own experience, to accomplish order delivery.

However, the existing order delivery approaches tend to have a phenomenon that delivery of some orders is forgotten, so that the delivery personnel needs to return to continue to deliver such orders, thereby resulting in low order delivery efficiency.

### SUMMARY

An object of embodiments of the present disclosure is to provide an improved method and apparatus for displaying an order, to solve the technical problems mentioned in the background part.

In a first aspect, an embodiment of the present disclosure provides a method for displaying an order, including: acquiring a first preset number of pieces of order data, the order data including delivery addresses; converting the delivery addresses of the acquired order data into three-dimensional coordinates corresponding to the delivery addresses of the acquired order data respectively; clustering the three-dimensional coordinates corresponding to the delivery addresses of the acquired order data to generate a second preset number of order sets; selecting at least one order set from the generated order sets; and displaying the order data included in the selected order set.

In some embodiments, the clustering the three-dimensional coordinates corresponding to the delivery addresses of the acquired order data to generate a second preset number of order sets includes: selecting the second preset number of pieces of order data from the acquired order data, and using the three-dimensional coordinates corresponding to the delivery addresses of the selected order data as initial clustering centers; executing following clustering: calculating distances between points indicated by the three-dimensional coordinates corresponding to the delivery addresses of the acquired order data and points indicated by the initial clustering centers respectively, using the distances as first distances, partitioning the acquired order data into the second preset number of order sets based on the first distances, calculating center coordinates of the three-dimensional coordinates corresponding to the delivery address of the order data included in the order sets respectively, using the center coordinates as clustering centers of the order sets, and determining whether the clustering centers of the order sets are identical to the initial clustering centers; and using the clustering centers of the order sets as the clustering centers, and continuing to execute the clustering, in response to determining the clustering centers of the order sets being different from the initial clustering centers.

In some embodiments, the selecting at least one order set from the generated order sets includes: statisticizing a number of pieces of order data included in the generated order sets respectively; and selecting an order set including a maximum number of pieces of order data from the generated order sets.

In some embodiments, the selecting at least one order set from the generated order sets includes: acquiring initial location information of a target delivery personnel and clustering centers of the generated order sets; converting the initial location information of the target delivery personnel into three-dimensional coordinates corresponding to the initial location information of the target delivery personnel; calculating distances between points indicated by the clustering centers of the generated order sets and a point indicated by the three-dimensional coordinates corresponding to the initial location information of the target delivery personnel respectively, and using the distances as second distances; and selecting an order set having a shortest second distance from the generated order sets.

In some embodiments, the displaying the order data included in the selected order set includes: calculating distances between points indicated by three-dimensional coordinates corresponding to delivery addresses of the order data included in the selected order set and the point indicated by the three-dimensional coordinates corresponding to the initial location information of the target delivery personnel respectively, and using the distances as third distances; sorting the order data included in the selected order set based on the third distances; and displaying the sorted order data.

In some embodiments, the order data further include an order category and an order-placing user grade; and the sorting the order data included in the selected order set based on the third distances includes: acquiring the order category and the order-placing user grade of the order data included in the selected order set; and sorting the order data included in the selected order set based on the third distances, the acquired order category, and the acquired order-placing user grade.

In some embodiments, the method further includes: determining whether there are order data corresponding to an undelivered order in the selected order set; acquiring current location information of the target delivery personnel in response to determining there being the order data corresponding to the undelivered order; converting the current location information of the target delivery personnel into three-dimensional coordinates corresponding to the current location information of the target delivery personnel; calculating a distance between a point indicated by the three-dimensional coordinates corresponding to the current location information of the target delivery personnel and a point indicated by three-dimensional coordinates corresponding to a delivery address of the order data corresponding to the undelivered order, and using the distance as a fourth distance; and outputting prompt information in response to the fourth distance being greater than a preset threshold.

In a second aspect, an embodiment of the present disclosure provides an apparatus for displaying an order, including: an order data acquiring unit, configured to acquire a first preset number of pieces of order data, the order data including delivery addresses; a delivery address converting unit, configured to convert the delivery addresses of the acquired order data into three-dimensional coordinates corresponding to the delivery addresses of the acquired order data respectively; an order set generating unit, configured to cluster the three-dimensional coordinates corresponding to the delivery addresses of the acquired order data to generate a second preset number of order sets; an order set selecting unit, configured to select at least one order set from the generated order sets; and an order data displaying unit, configured to display the order data included in the selected order set.

In some embodiments, the order set generating unit includes: an initial clustering center selecting subunit, configured to select the second preset number of pieces of order data from the acquired order data, and use the three-dimensional coordinates corresponding to the delivery addresses of the selected order data as initial clustering centers; an order data clustering subunit, configured to execute following clustering: calculating distances between points indicated by the three-dimensional coordinates corresponding to the delivery addresses of the acquired order data and points indicated by the initial clustering centers respectively, using the distances as first distances, partitioning the acquired order data into the second preset number of order sets based on the first distances, calculating center coordinates of the three-dimensional coordinates corresponding to the delivery addresses of the order data included in the order sets respectively, using the center coordinates as clustering centers of the order sets, and determining whether the clustering centers of the order sets are identical to the initial clustering centers; and a clustering center determining subunit, configured to use the clustering centers of the order sets as the initial clustering centers, and continue to execute the clustering, in response to determining the clustering centers of the order sets being different from the initial clustering centers.

In some embodiments, the order set selecting unit includes: a number statisticizing subunit, configured to statisticize a number of pieces of order data included in the generated order sets respectively; and a first order set selecting subunit, configured to select an order set including a maximum number of pieces of order data from the generated order sets.

In some embodiments, the order set selecting unit includes: a clustering center acquiring subunit, configured to acquire initial location information of a target delivery personnel and clustering centers of the generated order sets; an initial location information converting subunit, configured to convert the initial location information of the target delivery personnel into three-dimensional coordinates corresponding to the initial location information of the target delivery personnel; a second distance calculating subunit, configured to calculate distances between points indicated by the clustering centers of the generated order sets and a point indicated by the three-dimensional coordinates corresponding to the initial location information of the target delivery personnel respectively, and use the distances as second distances; and a second order set selecting subunit, configured to select an order set having a shortest second distance from the generated order sets.

In some embodiments, the order data displaying unit includes: a third distance calculating subunit, configured to calculate distances between points indicated by three-dimensional coordinates corresponding to delivery addresses of the order data included in the selected order set and the point indicated by the three-dimensional coordinates corresponding to the initial location information of the target delivery personnel respectively, and use the distances as third distances; an order data sorting subunit, configured to sort the order data included in the selected order set based on the third distances; and an order data displaying subunit, configured to display the sorted order data.

In some embodiments, the order data further include an order category and an order-placing user grade; and the order data sorting subunit includes: an acquiring module, configured to acquire the order category and the order-placing user grade of the order data included in the selected order set; and a sorting module, configured to sort the order data included in the selected order set based on the third distances, the acquired order category, and the acquired order-placing user grade

In some embodiments, the apparatus further includes: an undelivered order determining unit, configured to determine whether there are order data corresponding to an undelivered order in the selected order set; a current location information acquiring unit, configured to acquire current location information of a target delivery personnel in response to determining there being the order data corresponding to the undelivered order; a current location information converting unit, configured to convert the current location information of the target delivery personnel into three-dimensional coordinates corresponding to the current location information of the target delivery personnel; a fourth distance calculating unit, configured to calculate a distance between a point indicated by the three-dimensional coordinates corresponding to the current location information of the target delivery personnel and a point indicated by three-dimensional coordinates corresponding to a delivery address of the order data corresponding to the undelivered order, and use the distance as a fourth distance; and a prompt information outputting unit, configured to output prompt information in response to the fourth distance being greater than a preset threshold.

In a third aspect, an embodiment of the present disclosure provides an electronic device, including: one or more processors; and a storage apparatus, configured to store one or more programs, where the one or more programs, when executed by the one or more processors, cause the one or more processors to implement the method according to any one implementation in the first aspect.

In a fourth aspect, an embodiment of the present disclosure provides a computer readable storage medium, storing a computer program thereon, where the computer program, when executed by a processor, implements the method according to any one implementation in the first aspect.

The method and apparatus for displaying an order provided in the embodiments of the present disclosure convert delivery addresses of acquired order data into corresponding three-dimensional coordinates through acquiring a large amount of order data; then cluster the three-dimensional coordinates corresponding to the delivery addresses of the acquired order data to generate a plurality of order sets; and finally select at least one order set from the generated order sets, and display the order data included in the selected order set. By clustering a large amount of order data into a plurality of order sets, a delivery personnel delivers orders corresponding to the order sets sequentially, thereby facilitating improving the order delivery efficiency.

### BRIEF DESCRIPTION OF THE DRAWINGS

By reading detailed descriptions of non-limiting embodiments with reference to the following accompanying drawings, other features, objectives and advantages of the present disclosure will become more apparent.

FIG. 1 is a diagram of an exemplary system architecture in which an embodiment of the present disclosure may be implemented;

FIG. 2 is a flowchart of an embodiment of a method for displaying an order according to the present disclosure;

FIG. 3 is a schematic diagram of an application scenario of the method for displaying an order according to the present disclosure;

FIG. 4 is a flowchart of an embodiment of a method for generating an order set according to the present disclosure;

FIG. 5 is a schematic structural diagram of an embodiment of an apparatus for displaying an order according to the present disclosure; and

FIG. 6 is a schematic structural diagram of a computer system adapted to implement an electronic device of the embodiments of the present disclosure.

### DETAILED DESCRIPTION OF EMBODIMENTS

The present disclosure will be further described below in detail in combination with the accompanying drawings and the embodiments. It should be understood that the specific embodiments described herein are merely used for explaining the relevant disclosure, rather than limiting the disclosure. In addition, it should be further noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

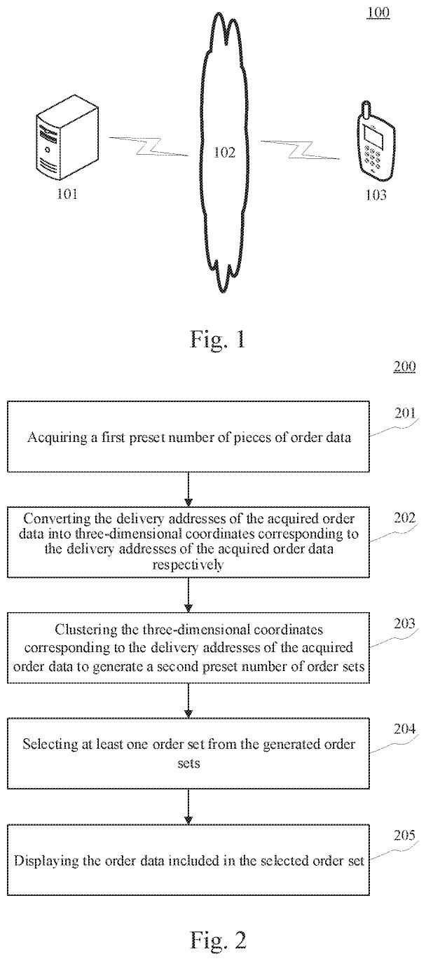

FIG. 1 shows an exemplary system architecture 100 in which a method for displaying an order or an apparatus for displaying an order of an embodiment of the present disclosure may be implemented.

As shown in FIG. 1, the system architecture 100 may include a server 101, a network 102, and a terminal device 103. The network 102 serves as a medium providing a communication link between the server 101 and the terminal device 103. The network 102 may include various types of connections, such as wired or wireless communication links, or optical fibers.

A target delivery personnel may interact with the server 101 using the terminal device 103 via the network 102, for example, to receive or send a message. For example, the target delivery personnel may acquire order data from the server 101 using the terminal device 103 via the network 102. The terminal device 103 may be various electronic devices, including but not limited to a smart phone, a tablet computer, a laptop portable computer, or the like.

The server 101 may be a server that provides various services. For example, the server 101 may be a backend server of an e-commerce site. The backend server can record users' order data on the e-commerce site, and sends the order data to the terminal device 103 when receiving a request from the terminal device 103.

It should be noted that the method for displaying an order provided in the embodiment of the present disclosure is generally executed by the terminal device 103. Accordingly, the apparatus for displaying an order is generally provided in the terminal device 103.

It should be understood that the numbers of servers, networks, and terminal devices in FIG. 1 are merely illustrative. Any number of servers, networks, and terminal devices may be provided based on actual requirements.

Further referring to FIG. 2, a process 200 of an embodiment of a method for displaying an order according to the present disclosure is shown. The method for displaying an order includes the following steps.

Step 201: acquiring a first preset number of pieces of order data.

In the present embodiment, an electronic device (e.g., the terminal device 103 shown in FIG. 1) on which the method for displaying an order is performed may acquire a large amount of order data from a backend server (e.g., the server 101 shown in FIG. 1) of an e-commerce site via a wired or wireless connection. Each piece of order data may include a corresponding delivery address. In general, the delivery address is an address of an order-placing user.

In the present embodiment, the order data may be order-related data of the user in the e-commerce site. The order data may include, but are not limited to: information of the e-commerce site (e.g., a name of the e-commerce site, a contact number of the e-commerce site, and an address of the e-commerce site), information of the order-placing user (e.g., an account name of the order-placing user, a contact number of the order-placing user, an address of the order-placing user, and a grade of the order-placing user), and information of an ordered item (e.g., a name of the ordered item, a SKU (Stock Keeping Unit) of the ordered item, a category of the ordered item, and a price of the ordered item).

Step 202: converting the delivery addresses of the acquired order data into three-dimensional coordinates corresponding to the delivery addresses of the acquired order data respectively.

In the present embodiment, the electronic device can convert the delivery addresses of the acquired order data into the corresponding three-dimensional coordinates respectively based on the delivery addresses of the order data acquired in step 201.

In the present embodiment, a geocentric coordinate system can be selected, where the geocentric coordinate system is a spatial rectangular coordinate system established with the geocenter as the origin. The origin O is located at the center of mass of the earth body, and the coordinate system is denoted by mutually perpendicular X, Y, Z axes. The X axis coincides with an intersection line of the first meridian plane and the equatorial plane, and is positive eastward. The Z axis coincides with the rotation axis of the earth, and is positive northward. The Y axis is perpendicular to the XZ plane, and forms a right-handed system. In practice, in order to facilitate calculation, the earth is generally regarded as a standard sphere, and the center of the sphere is used as the origin of the geocentric coordinate system.

In some alternative implementations of the present embodiment, the electronic device can first convert a delivery address into longitude and latitude coordinates (lon, lat) corresponding to the delivery address; and then convert the longitude and latitude coordinates corresponding to the delivery address into corresponding three-dimensional coordinates (x, y, z) by the following equation:

$$\{ \begin{matrix}x = R \times cos ( lat ) \times cos ( lon ) \\ y = R \times cos ( lat ) \times sin ( lon ) \\ z = R \times sin ( lat )\end{matrix} .$$

Here, x is a coordinate of a point indicated by the three-dimensional coordinates (x, y, z) corresponding to the delivery address in an X-axis direction, y is a coordinate of the point indicated by the three-dimensional coordinates (x, y, z) corresponding to the delivery address in a Y-axis direction, z is a coordinate of the point indicated by the three-dimensional coordinates (x, y, z) corresponding to the delivery address in a Z-axis direction, lon is a longitude of the longitude and latitude coordinates (lon, lat) corresponding to the delivery address, lat is a latitude of the latitude and longitude coordinates (lon, lat) corresponding to the delivery address, and R is the radius of the earth.

Step 203: clustering the three-dimensional coordinates corresponding to the delivery addresses of the acquired order data to generate a second preset number of order sets.

In the present embodiment, the electronic device can cluster the three-dimensional coordinates corresponding to the delivery addresses of the acquired order data based on the three-dimensional coordinates corresponding to the delivery addresses of the order data acquired in step 202, to generate the second preset number of order sets. The clustering is generally a process of partitioning a large number of physical or abstract objects into a plurality of sets composed of similar objects. These objects are similar to objects in the same set, but are different from objects in other sets.

The clustering method employed here is generally a partitioning method. Specifically, given a data set having N (e.g., the first preset number of) records, K (e.g., the second preset number of) groups are constituted using a splitting method, where N and K are positive integers, and K<N. And the K groups meet two conditions below:
1. Each group includes at least one data record; and
2. Each data record belongs to, and merely belongs to, one group.

For a given K, first, an initial grouping method is given, and then grouping is changed by repeated iteration, such that a grouping scheme changed each time is better over a grouping scheme last time. The so-called standard of good grouping scheme is that: it is better that the closer data records are in the same group, and the farther data records are in different groups. Algorithms using this basic idea may include, but are not limited to: a K-MEANS algorithm, a K-MEDOIDS algorithm, CLARANS (Clustering Algorithm based on Randomized Search), or the like.

Step 204: selecting at least one order set from the generated order sets.

In the present embodiment, the electronic device can select at least one order set from the generated order sets based on the order data sets generated in step 203. In practice, the target delivery personnel delivers items corresponding to the order sets sequentially, and generally, the electronic device selects one order set from the generated order sets each time.

In some alternative implementations of the present embodiment, the electronic device can first statisticize the number of pieces of order data included in the generated order sets respectively; and then select an order set including a maximum number of pieces of order data from the generated order sets. The larger is the number of pieces of order data included in an order set, the more intensive are orders in a delivery region corresponding to the order set. The orders in the order-intensive region can be delivered preferentially through this select approach.

In some alternative implementations of the present embodiment, the electronic device can first acquire initial location information of a target delivery personnel and clustering centers of the generated order sets; then convert the initial location information of the target delivery personnel into three-dimensional coordinates corresponding to the initial location information of the target delivery personnel; then calculate distances between points indicated by the clustering centers of the generated order sets and a point indicated by the three-dimensional coordinates corresponding to the initial location information of the target delivery personnel respectively, and use the distances as second distances; and finally select an order set having a shortest second distance from the generated order sets. The initial location information of the target delivery personnel may be current location information of the target delivery personnel, or location information of a delivery site of an item corresponding to the order set. The clustering center may be center coordinates of the three-dimensional coordinates corresponding to the delivery addresses of the order data included in the order set. The second distance may be an arc length between a point indicated by a clustering center of an order set and a point indicated by the three-dimensional coordinates corresponding to the initial location information of the target delivery personnel. The shorter is the second distance, the closer is the target delivery personnel from the region corresponding to the order set. Orders around the target delivery personnel can be delivered preferentially through this selecting approach.

Specifically, the electronic device can calculate the second distance L as follows.

First, if a point indicated by three-dimensional coordinates (x₁, y₁, z₁) corresponding to the initial location information of the target delivery personnel is A, and a point indicated by a clustering center (x₂, y₂, z₂) in the order set is B, then the electronic device can calculate a cosine of a central angle AOB by the following equation:

$$cos AOB = \frac{{x}_{1} \times {x}_{2} \times + {y}_{1} \times {y}_{2} + {z}_{1} \times {z}_{2}}{\sqrt{{x}_{1}^{2} + {y}_{1}^{2} + {z}_{1}^{2}} \times \sqrt{{x}_{2}^{2} + {y}_{2}^{2} + {z}_{2}^{2}}} .$$

Here, x₁ is a coordinate of A in the X-axis direction, y₁ is a coordinate of A in the Y-axis direction, z₁ is a coordinate of A in the Z-axis direction, x₂ is a coordinate of B in the X-axis direction, y₂ is a coordinate of B in the Y-axis direction, and z₂ is a coordinate of B in the Z-axis direction.

Then, the electronic device can calculate a sine of the central angle AOB by the following equation:

sin AOB=\sqrt{1−cos²AOB}.

Finally, since the central angle AOB tends to be relatively small, in this case, the sine of the central angle AOB may be approximately equal to a radian of the central angle AOB, and then the electronic device can calculate the second distance L by the following equation:

L=R×sin AOB.

Here, R is the radius of the earth.

Step 205: displaying the order data included in the selected order set.

In the present embodiment, the electronic device can display the order data included in the selected order set based on the order set selected in step 204, such that the target delivery personnel can deliver orders based on the order data displayed on the electronic device.

In some alternative implementations of the present embodiment, the electronic device can first calculate distances between points indicated by three-dimensional coordinates corresponding to delivery addresses of the order data included in the selected order set and the point indicated by the three-dimensional coordinates corresponding to the initial location information of the target delivery personnel respectively, and use the distances as third distances; then sort the order data included in the selected order set based on the third distances; and finally display the sorted order data. The third distance (for which the calculating the second distance may be referred to) may be an arc length between a point indicated by three-dimensional coordinates corresponding to a delivery address of order data and the point indicated by the three-dimensional coordinates corresponding to the initial location information of the target delivery personnel. The shorter is the third distance, the closer is the target delivery personnel from the delivery address of the order data. The order near the target delivery personnel can be delivered preferentially through this sorting approach.

In some alternative implementations of the present embodiment, the electronic device can first acquire an order category and an order-placing user grade of the order data included in the selected order set; and then sort the order data included in the selected order set based on the third distances, the acquired order category, and the acquired order-placing user grade. The order data may further include the order category and the order-placing user grade. For example, the order category may include, but is not limited to, a fresh food category, a luxury category, an electronic product category, a clothing category, or the like. The order-placing user grade may include, but is not limited to, a diamond grade, a gold grade, a silver grade, a copper grade, or the like. As an example, the electronic device can set different weights for the third distance, the order category, and the order-placing user grade, to acquire a total weight of the order data, and sort the order data based on the total weight. Fresh food orders, and orders of order-placing users of high grades can be delivered preferentially through this sorting approach.

In some alternative implementations of the present embodiment, the electronic device can further first determine whether there are order data corresponding to an undelivered order in the selected order set, acquire current location information of the target delivery personnel in the case of determining there being the order data corresponding to the undelivered order; convert the current location information of the target delivery personnel into three-dimensional coordinates corresponding to the current location information of the target delivery personnel; then calculate a distance between a point indicated by the three-dimensional coordinates corresponding to the current location information of the target delivery personnel and a point indicated by three-dimensional coordinates corresponding to a delivery address of the order data corresponding to the undelivered order, and use the distance as a fourth distance; and finally output prompt information in the case where the fourth distance is greater than a preset threshold. The fourth distance (for which the calculating the second distance may be referred to) may be an arc length between the point indicated by the three-dimensional coordinates corresponding to the current location information of the target delivery personnel and the point indicated by the three-dimensional coordinates corresponding to the delivery address of the order data corresponding to the undelivered order. When there are the order data corresponding to the undelivered order in the order set, the target delivery personnel can be timely reminded to perform order delivery, thereby avoiding occurrence of a phenomenon of forgetting delivery of an order, and then improving the order delivery efficiency.

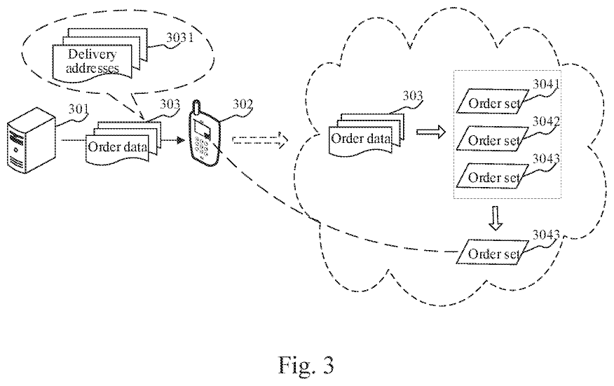

Further referring to FIG. 3, FIG. 3 is a schematic diagram of an application scenario of the method for displaying an order according to the present disclosure. In the application scenario of FIG. 3, first, a terminal device 302 can acquire a large amount of order data 303 from a backend server 301 of an e-commerce site, where each piece of order data 303 may include a delivery address 3031; then, the terminal device 302 can convert the delivery addresses 3031 of the acquired order data 303 into corresponding three-dimensional coordinates, to facilitate clustering the three-dimensional coordinates corresponding to the delivery addresses 3031 of the acquired order data 303, and generating order sets 3041, 3042, and 3043; and finally, the terminal device 302 selects the order set 3043 from the order sets 3041, 3042, and 3043, and displays the order data included in the order set 3043.

The method for displaying an order provided in the embodiments of the present disclosure converts delivery addresses of acquired order data into corresponding three-dimensional coordinates through acquiring a large amount of order data; then clusters the three-dimensional coordinates corresponding to the delivery addresses of the acquired order data to generate a plurality of order sets; and finally selects at least one order set from the generated order sets, and displays the order data included in the selected order set. By clustering a large amount of order data into a plurality of order sets, a delivery personnel delivers orders corresponding to the order sets sequentially, thereby facilitating improving the order delivery efficiency.

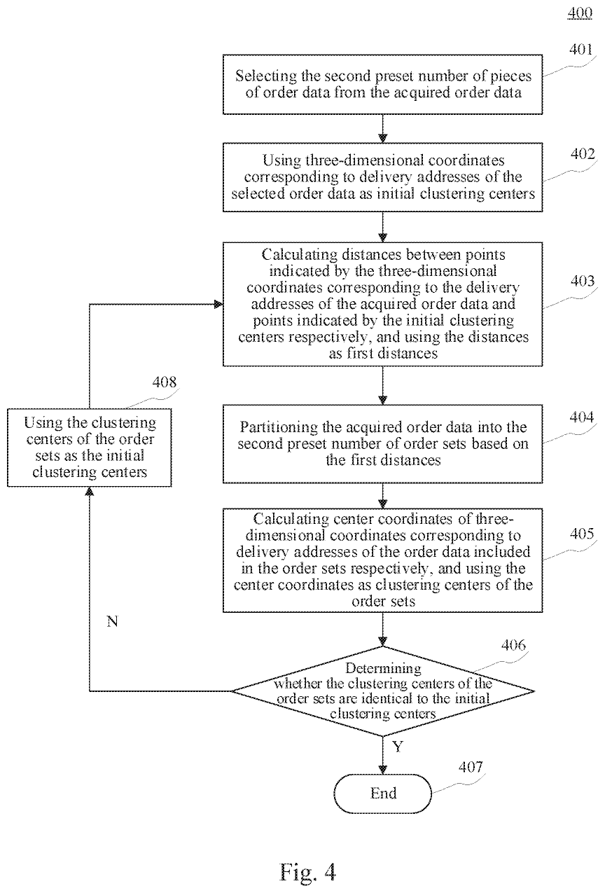

Further referring to FIG. 4, a process 400 of an embodiment of a method for generating an order set is shown. The process 400 of the method for generating an order set includes the following steps.

Step 401: selecting the second preset number of pieces of order data from the acquired order data.

In the present embodiment, an electronic device (e.g., the terminal device 103 shown in FIG. 1) can select the second preset number of pieces of order data from the acquired order data. As an example, the electronic device can select any K pieces of order data from acquired N pieces of order data. N and K are positive integers.

Step 402: using three-dimensional coordinates corresponding to delivery addresses of the selected order data as initial clustering centers.

In the present embodiment, the electronic device can use the three-dimensional coordinates corresponding to the delivery addresses of the order data selected in step 401 as the initial clustering centers.

Step 403: calculating distances between points indicated by the three-dimensional coordinates corresponding to the delivery addresses of the acquired order data and points indicated by the initial clustering centers respectively, and using the distances as first distances.

In the present embodiment, the electronic device can calculate the distances between the points indicated by the three-dimensional coordinates corresponding to the delivery addresses of the acquired order data and the points indicated by the initial clustering centers respectively, and use the distances as the first distances. The first distance (for which the calculating the second distance maybe referred to) may be an arc length between a point indicated by three-dimensional coordinates corresponding to a delivery address of order data and a point indicated by an initial clustering center.

Step 404: partitioning the acquired order data into the second preset number of order sets based on the first distances.

In the present embodiment, the electronic device can partition the acquired order data into the second preset number of order sets based on the first distances calculated in step 403. A delivery region corresponding to each order set includes a point indicated by one of the initial clustering centers. Each order set includes at least one piece of order data. Each piece of order data belongs to, and merely belongs to, one order set.

Specifically, for each piece of order data, the electronic device can calculate a distance between a point indicated by three-dimensional coordinates corresponding to a delivery address of the piece of order data and the points indicated by the initial clustering centers respectively, and incorporate the piece of order data into an order set corresponding to an initial clustering center having a shortest distance from the piece of order data.

Step 405: calculating center coordinates of three-dimensional coordinates corresponding to delivery addresses of the order data included in the order sets respectively, and using the center coordinates as clustering centers of the order sets.

In the present embodiment, the electronic device can calculate the center coordinates of the three-dimensional coordinates corresponding to the delivery addresses of the order data included in the order sets respectively, and use the center coordinates as the clustering centers of the order sets. The center coordinate of three-dimensional coordinates corresponding to delivery addresses of order data included in an order set is a mean of the three-dimensional coordinates corresponding to the delivery addresses of the order data included in the order set.

Step 406: determining whether the clustering centers of the order sets are identical to the initial clustering centers.

In the present embodiment, the electronic device can determine whether the clustering centers of the order sets are identical to the initial clustering centers; execute step 407 in the case that the clustering centers of the order sets are identical to the initial clustering centers; and execute step 408 in the case that the clustering centers of the order sets are different from the initial clustering centers.

Step 407: the process ends

Step 408: using the clustering centers of the order sets as the initial clustering centers.

In the present embodiment, the electronic device can use the clustering centers of the order sets as the initial clustering centers, and return to execute step 403, in the case that the clustering centers of the order sets are different from the initial clustering centers.

The method for generating an order set provided in the embodiment of the present disclosure first selects the second preset number of pieces of order data from the acquired order data, and uses the three-dimensional coordinates corresponding to the delivery addresses of the selected order data as initial clustering centers; then executes the following clustering: calculating distances between points indicated by the three-dimensional coordinates corresponding to the delivery addresses of the acquired order data and points indicated by the initial clustering centers respectively, using the distances as first distances, partitioning the acquired order data into the second preset number of order sets based on the first distances, calculating center coordinates of the three-dimensional coordinates corresponding to the delivery address of the order data included in the order sets respectively, using the center coordinates as clustering centers of the order sets, and determining whether the clustering centers of the order sets are identical to the initial clustering centers; and finally ends the clustering, if determining the clustering centers of the order sets being identical to the initial clustering centers, which indicates the generated order sets no longer changing; and uses the clustering centers of the order sets as the initial clustering centers, and continues to execute the clustering until the generated order sets no longer change, if determining the clustering centers of the order sets being different from the initial clustering centers, thereby achieving a delivery region corresponding to the same order set being compact as much as possible, while delivery regions corresponding to different order sets being separated as much as possible.

Further referring to FIG. 5, as an implementation of the method shown in the above figures, the present disclosure provides an embodiment of an apparatus for displaying an order. The embodiment of the apparatus corresponds to the embodiment of the method shown in FIG. 2, and the apparatus may be specifically applied to various electronic devices.

As shown in FIG. 5, the apparatus 500 for displaying an order of the present embodiment may include: an order data acquiring unit 501, a delivery address converting unit 502, an order set generating unit 503, an order set selecting unit 504, and an order data displaying unit 505. The order data acquiring unit 501 is configured to acquire a first preset number of pieces of order data, the order data including delivery addresses; the delivery address converting unit 502 is configured to convert the delivery addresses of the acquired order data into three-dimensional coordinates corresponding to the delivery addresses of the acquired order data respectively; the order set generating unit 503 is configured to cluster the three-dimensional coordinates corresponding to the delivery addresses of the acquired order data to generate a second preset number of order sets; the order set selecting unit 504 is configured to select at least one order set from the generated order sets; and the order data displaying unit 505 is configured to display the order data included in the selected order set.

In the present embodiment, the specific processing of the order data acquiring unit 501, the delivery address converting unit 502, an order set generating unit 503, the order set selecting unit 504, and the order data displaying unit 505 of the apparatus 500 for displaying an order and the technical effects thereof may be referred to the related description in step 201, step 202, and step 203, step 204, and step 205 in the corresponding embodiment of FIG. 2, respectively. The description will not be repeated here.

In some alternative implementations of the present embodiment, the order set generating unit 503 may include: an initial clustering center selecting subunit (not shown in the figure), configured to select the second preset number of pieces of order data from the acquired order data, and use the three-dimensional coordinates corresponding to the delivery addresses of the selected order data as initial clustering centers; an order data clustering subunit (not shown in the figure), configured to execute following clustering: calculating distances between points indicated by the three-dimensional coordinates corresponding to the delivery addresses of the acquired order data and points indicated by the initial clustering centers respectively, using the distances as first distances, partitioning the acquired order data into the second preset number of order sets based on the first distances, calculating center coordinates of the three-dimensional coordinates corresponding to the delivery addresses of the order data included in the order sets respectively, using the center coordinates as clustering centers of the order sets, and determining whether the clustering centers of the order sets are identical to the initial clustering centers; and a clustering center determining subunit (not shown in the figure), configured to use the clustering centers of the order sets as the initial clustering centers, and continue to execute the clustering, in response to determining the clustering centers of the order sets being different from the initial clustering centers.

In some alternative implementations of the present embodiment, the order set selecting unit 504 may include: a number statisticizing subunit (not shown in the figure), configured to statisticize a number of pieces of order data included in the generated order sets respectively; and a first order set selecting subunit (not shown in the figure), configured to select an order set including a maximum number of pieces of order data from the generated order sets.

In some alternative implementations of the present embodiment, the order set selecting unit 504 may include: a clustering center acquiring subunit (not shown in the figure) configured to acquire initial location information of a target delivery personnel and clustering centers of the generated order sets; an initial location information converting subunit (not shown in the figure), configured to convert the initial location information of the target delivery personnel into three-dimensional coordinates corresponding to the initial location information of the target delivery personnel; a second distance calculating subunit (not shown in the figure), configured to calculate distances between points indicated by the clustering centers of the generated order and a point indicated by the three-dimensional coordinates corresponding to the initial location information of the target delivery personnel respectively, and use the distances as second distances; and a second order set selecting subunit (not shown in the figure), configured to select an order set having a shortest second distance from the generated order sets.

In some alternative implementations of the present embodiment, the order data displaying unit 505 may include: a third distance calculating subunit (not shown in the figure), configured to calculate distances between points indicated by three-dimensional coordinates corresponding to delivery addresses of the order data included in the selected order set and the point indicated by the three-dimensional coordinates corresponding to the initial location information of the target delivery personnel respectively, and use the distances as third distances; an order data sorting subunit (not shown in the figure), configured to sort the order data included in the selected order set based on the third distances; and an order data displaying subunit (not shown in the figure), configured to display the sorted order data.

In some alternative implementations of the present embodiment, the order data may further include an order category and an order-placing user grade; and the order data sorting subunit may include: an acquiring module (not shown in the figure), configured to acquire the order category and the order-placing user grade of the order data included in the selected order set; and a sorting module (not shown in the figure), configured to sort the order data included in the selected order set based on the third distances, the acquired order category, and the acquired order-placing user grade.

In some alternative implementations of the present embodiment, the apparatus 500 for displaying an order may further include: an undelivered order determining unit (not shown in the figure), configured to determine whether there are order data corresponding to an undelivered order in the selected order set; a current location information acquiring unit (not shown in the figure) configured to acquire current location information of a target delivery personnel in response to determining there being the order data corresponding to the undelivered order; a current location information converting unit (not shown in the figure), configured to convert the current location information of the target delivery personnel into three-dimensional coordinates corresponding to the current location information of the target delivery personnel; a fourth distance calculating unit (not shown in the figure), configured to calculate a distance between a point indicated by the three-dimensional coordinates corresponding to the current location information of the target delivery personnel and a point indicated by three-dimensional coordinates corresponding to a delivery address of the order data corresponding to the undelivered order, and use the distance as a fourth distance; and a prompt information outputting unit (not shown in the figure), configured to output prompt information in response to the fourth distance being greater than a preset threshold.

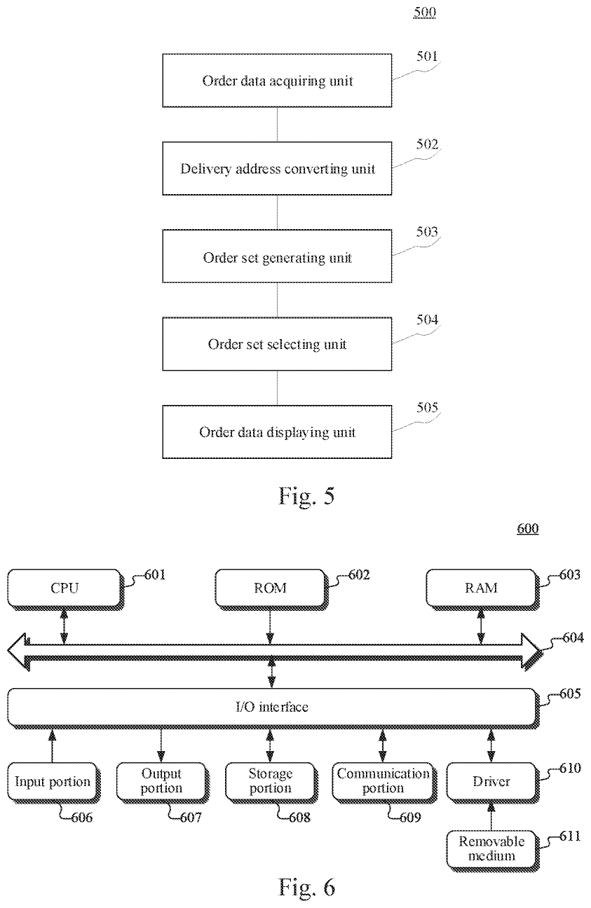

Referring to FIG. 6 below, a schematic structural diagram of a computer system 600 adapted to implement an electronic device of embodiments of the present disclosure is shown. The electronic device shown in FIG. 6 is merely an example, and should not limit the functions and scope of use of the embodiments of the present disclosure.

As shown in FIG. 6, the computer system 600 includes a central processing unit (CPU) 601, which may execute various appropriate actions and processes accordance with a program stored in a read only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, or the like; an output portion 607 including a cathode ray tube (CRT), a liquid crystal display device (LCD), a speaker, or the like; a storage portion 608 including a hard disk, or the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, so that a computer program read therefrom is installed on the storage portion 608 as needed.

In particular, according to embodiments of the present disclosure, the process described above with reference to the flow chart maybe implemented in a computer software program. For example, an embodiment of the present disclosure includes a computer program product, which comprises a computer program that is tangibly embedded in a computer readable medium. The computer program includes program codes for executing the method as illustrated in the flow chart. In such an embodiment, the computer program may be downloaded and installed from a network via the communication portion 609, and/or may be installed from the removable medium 611. The computer program, when executed by the central processing unit (CPU) 601, implements the above functions as defined by the method of the present disclosure.

It should be noted that the computer readable medium may be a computer readable signal medium or a computer readable storage medium or any combination of the above two. An example of the computer readable storage medium may include, but is not limited to: electric, magnetic, optical, electromagnetic, infrared, or semiconductor systems, apparatuses, elements, or a combination of any of the above. A more specific example of the computer readable storage medium may include, but is not limited to: electrical connection with one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above. In the present disclosure, the computer readable storage medium may be any tangible medium containing or storing programs, which may be used by, or used in combination with, a command execution system, apparatus or element. In the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, command execution system, apparatus or element. The program codes contained on the computer readable medium may be transmitted with any suitable medium, including but not limited to: wireless, wired, optical cable, RF medium, etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logical functions. It should be further noted that, in some alternative implementations, the functions denoted by the blocks may occur in a sequence different from the sequences shown in the figures. For example, any two blocks presented in succession may be executed substantially in parallel, or they may sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, described as: a processor, including an order data acquiring unit, a delivery address converting unit, an order set generating unit, an order set selecting unit, and an order data displaying unit. The names of the units do not constitute a limitation to such units themselves in some cases. For example, the order data acquiring unit may be further described as “a unit configured to acquire a first preset number of pieces of order data.”

In another aspect, the present disclosure further provides a computer readable medium. The computer readable medium may be included in the electronic device described in the above embodiments, or a stand-alone computer readable medium without being assembled into the electronic device. The computer readable medium stores one or more programs. The one or more programs, when executed by the electronic device, cause the electronic device to: acquire a first preset number of pieces of order data, the order data including delivery addresses; convert the delivery addresses of the acquired order data into three-dimensional coordinates corresponding to the delivery addresses of the acquired order data respectively; cluster the three-dimensional coordinates corresponding to the delivery addresses of the acquired order data to generate a second preset number of order sets; select at least one order set from the generated order sets; and display the order data included in the selected order set.

The above description only provides explanation of the preferred embodiments of the present disclosure and the employed technical principles. It should be appreciated by those skilled in the art. that the inventive scope of the present disclosure is not limited to the technical solutions formed by the particular combinations or the above-described technical features. The inventive scope should also cover other technical solutions formed by any combination of the above-described technical features or equivalent features thereof without departing from the concept of the disclosure, for example, technical solutions formed by the above-described features being interchanged with, but not limited to, technical features with similar functions disclosed in the present disclosure.

1. A method for displaying an order, comprising:
acquiring a first preset number of pieces of order data, the order data including delivery addresses;
converting the delivery addresses of the acquired order data into three-dimensional coordinates corresponding to the delivery addresses of the acquired order data respectively;
clustering the three-dimensional coordinates corresponding to the delivery addresses of the acquired order data to generate a second preset number of order sets;
selecting at least one order set from the generated order sets; and
displaying the order data included in the selected order set.

2. The method according to claim 1, wherein the clustering the three-dimensional coordinates corresponding to the delivery addresses of the acquired order data to generate a second preset number of order sets comprises:
selecting the second preset number of pieces of order data from the acquired order data, and using the three-dimensional coordinates corresponding to the delivery addresses of the selected order data as initial clustering centers;
executing following clustering: calculating distances between points indicated by the three-dimensional coordinates corresponding to the delivery addresses of the acquired order data and points indicated by the initial clustering centers respectively, using the distances as first distances, partitioning the acquired order data into the second preset number of order sets based on the first distances, calculating center coordinates of the three-dimensional coordinates corresponding to the delivery addresses of the order data included in the order sets respectively, using the center coordinates as clustering centers of the order sets, and determining whether the clustering centers of the order sets are identical to the initial clustering centers; and
using the clustering centers of the order sets as the initial clustering centers, and continuing to execute the clustering, in response to determining the clustering centers of the order sets being different from the initial clustering centers.

3. The method according to claim 1, wherein the selecting at least one order set from the generated order sets comprises:
statisticizing a number of pieces of order data included in the generated order sets respectively; and
selecting an order set including a maximum number of pieces of order data from the generated order sets.

4. The method according to claim 1, wherein the selecting at least one order set from the generated order sets comprises:
acquiring initial location information of a target delivery personnel and clustering centers of the generated order sets;
converting the initial location information of the target delivery personnel into three-dimensional coordinates corresponding to the initial location information of the target delivery personnel;
calculating distances between points indicated by the clustering centers of the generated order sets and a point indicated by the three-dimensional coordinates corresponding to the initial location information of the target delivery personnel respectively, and using the distances as second distances; and
selecting an order set having a shortest second distance from the generated order sets.

5. The method according to claim 4, wherein the displaying the order data included in the selected order set comprises:
calculating distances between points indicated by three-dimensional coordinates corresponding to delivery addresses of the order data included in the selected order set and the point indicated by the three-dimensional coordinates corresponding to the initial location information of the target delivery personnel respectively, and using the distances as third distances;
sorting the order data included in the selected order set based on the third distances; and
displaying the sorted order data.

6. The method according to claim 5, wherein the order data further comprise an order category and an order-placing user grade; and
the sorting the order data included in the selected order set based on the third distances comprises:
acquiring the order category and the order-placing user grade of the order data included in the selected order set; and
sorting the order data included in the selected order set based on the third distances, the acquired order category, and the acquired order-placing user grade.

7. The method according to claim 1, further comprising:
determining whether there are order data corresponding to an undelivered order in the selected order set;
acquiring current location information of the target delivery personnel in response to determining there being the order data corresponding to the undelivered order;
converting the current location information of the target delivery personnel into three-dimensional coordinates corresponding to the current location information of the target delivery personnel;
calculating a distance between a point indicated by the three-dimensional coordinates corresponding to the current location information of the target delivery personnel and a point indicated by three-dimensional coordinates corresponding to a delivery address of the order data corresponding to the undelivered order, and using the distance as a fourth distance; and
outputting prompt information in response to the fourth distance being greater than a preset threshold.

8. An apparatus for displaying an order, comprising:
at least one processor; and
a memory storing instructions, the instructions when executed by the at least one processor, cause the at least one processor to perform operations, the operations comprising:
acquiring a first preset number of pieces of order data, the order data including delivery addresses;
converting the delivery addresses of the acquired order data into three-dimensional coordinates corresponding to the delivery addresses of the acquired order data respectively;
clustering the three-dimensional coordinates corresponding to the delivery addresses of the acquired order data to generate a second preset number of order sets;
selecting at least one order set from the generated order sets; and
displaying the order data included in the selected order set.

9. The apparatus according to claim 8, wherein the clustering the three-dimensional coordinates corresponding to the delivery addresses of the acquired order data to generate a second preset number of order sets comprises:
selecting the second preset number of pieces of order data from the acquired order data, and use the three dimensional coordinates corresponding to the delivery addresses of the selected order data as initial clustering centers;
executing following clustering: calculating distances between points indicated by the three-dimensional coordinates corresponding to the delivery addresses of the acquired order data and points indicated by the initial clustering centers respectively, using the distances as first distances; partitioning the acquired order data into the second preset number of order sets based on the first distances; calculating center coordinates of the three-dimensional coordinates corresponding to the delivery addresses of the order data included in the order sets respectively, using the center coordinates as clustering centers of the order sets; and determining whether the clustering centers of the order sets are identical to the initial clustering centers; and
using the clustering centers of the order sets as the initial clustering centers, and continue to execute the clustering, in response to determining the clustering centers of the order sets being different from the initial clustering centers,

10. The apparatus according to claim 8, the operations further comprising:
determining whether there are order data corresponding to an undelivered order in the selected order set;
acquiring current location information of a target delivery personnel in response to determining there being the order data corresponding to the undelivered order;
converting the current location information of the target delivery personnel into three-dimensional coordinates corresponding to the current location information of the target delivery personnel;
calculating a distance between a point indicated by the three-dimensional coordinates corresponding to the current location information of the target delivery personnel and a point indicated by three-dimensional coordinates corresponding to a delivery address of the order data corresponding to the undelivered order, and use the distance as a fourth distance; and
outputting prompt information in response to the fourth distance being greater than a preset threshold.

11. (canceled)

12. A non-transitory computer readable storage medium, storing a computer program thereon, wherein the computer program, when executed by a processor causes the processor to perform operations, the operations comprising:
acquiring a first preset number of pieces of order data, the order data including delivery addresses;
converting the delivery addresses of the acquired order data into three-dimensional coordinates corresponding to the delivery addresses of the acquired order data respectively;
clustering the three-dimensional coordinates corresponding to the delivery addresses of the acquired order data to generate a second preset number of order sets;
selecting at least one order set from the generated order sets; and
displaying the order data included in the selected order set.

13. The apparatus according to claim 8, wherein the selecting at least one order set from the generated order sets comprises:
statisticizing a number of pieces of order data included in the generated order sets respectively; and
selecting an order set including a maximum number of pieces of order data from the generated order sets.

14. The apparatus according to claim 8, wherein the selecting at least one order set from the generated order sets comprises:
acquiring initial location information of a target delivery personnel and clustering centers of the generated order sets;
converting the initial location information of the target delivery personnel into three-dimensional coordinates corresponding to the initial location information of the target delivery personnel;
calculating distances between points indicated by the clustering centers of the generated order sets and a point indicated by the three-dimensional coordinates corresponding to the initial location information of the target delivery personnel respectively, and using the distances as second distances; and
selecting an order set having a shortest second distance from the generated order sets.

15. The apparatus according to claim 14, wherein the displaying the order data included in the selected order set comprises:
calculating distances between points indicated by three-dimensional coordinates corresponding to delivery addresses of the order data included in the selected order set and the point indicated by the three-dimensional coordinates corresponding to the initial location information of the target delivery personnel respectively, and using the distances as third distances;
sorting the order data included in the selected order set based on the third distances; and
displaying the sorted order data.

16. The apparatus according to claim 15, wherein the order data further comprise an order category and an order-placing user grade; and
the sorting the order data included in the selected order set based on the third distances comprises:
acquiring the order category and the order-placing user grade of the order data included in the selected order set; and
sorting the order data included in the selected order set based on the third distances, the acquired order category, and the acquired order-placing user grade.
